(19) United States
(12) Patent Application Publication
(10) Pub. No.: US 2025/0002265 A1
(43) Pub. Date: Jan. 2, 2025

(54) TRANSPORT SYSTEM

(71) Applicant: OmniMod AS, Fornebu Oslo (NO)

(72) Inventors: Vsevolod Arkadiivich Karpov, Fornebu Oslo (NO); Tobias Drage Roti, Fornebu Oslo (NO)

(21) Appl. No.: 18/292,816

(22) PCT Filed: Jul. 28, 2021
(86) PCT No.: PCT/EP2021/071201

§ 371 Date: Jan. 26, 2024

(51) Int. Cl. B65G 47/64; B65G 13/10; B65G 43/08

(52) U.S. Cl. CPC B65G 47/64; B65G 13/10; B65G 43/08; B65G 2203/0216; B65G 2207/30

(57) ABSTRACT

A conveying system for conveying objects comprising: a plurality of conveyor modules, each conveyor module comprising: at least one rotatable element comprising an engagement surface configured to engage with a surface of an object to be conveyed; a driving mechanism configured to rotate the at least one rotatable element such that rotation of the at least one rotatable element causes rotation of the engagement surface and thereby movement of the object; and a control mechanism configured to control rotation of the rotatable element via the driving mechanism; and a conveying frame comprising: a plurality of apertures, each aperture configured to receive a conveyor module so as to form an array of conveyor modules that together provide a substantially planar surface for conveying objects thereon; a control system configured to communicate with the control mechanism of the conveyor module; wherein each conveyor module is configured to be releasably mounted within an aperture; wherein mounting a conveyor module within an aperture establishes an electrical connection between the control mechanism and the control system, which facilitates electrical communication between the control system and the mounted conveyor module.

### FIELD OF THE INVENTION

The present invention relates to a system for moving a plurality of objects within an object transport system.

### BACKGROUND

Sorting systems, for example for package sorting systems, typically include a conveying system which is able to receive packages and route them to their destination. The conveying system includes a transporting surface, such as a conveyor belt or a system of cooperating wheels, on which the package rests and is moved about by a central control system. The transporting surfaces can take a number of different forms, as follows.

A first example conveying system includes a conveyor belt ring having multiple feed-in and feed-out paths attached to the main ring. Packages are conveyed to the central ring via the feed-in conveying paths and are transported round the ring until each package reaches its designated fee-out conveyor path. A problem with this system is that the conveying system is a generally large, fixed system of conveyor belts and so flexibility of the conveying paths is very limited. Furthermore, these systems are typically too large and expensive to be accessible to small and medium sized facilities. These systems are not able to easily adjust their functionality or configuration.

A second example conveying system includes a shuttle robot system in which carrier robots move around a floor to collect and distribute packages around different locations on the floor. However, this system is only able to move packages in two dimensions. Further, a limited number of carrier robots operate at a given time and so the number of packages being transported at a given time is also limited. In addition, carrier robots on the other hand are designed to carry objects of fixed size, thus being inefficient in situations where there is large variability in size of the objects that need to be handled.

A third example conveying system includes transportation layer for the transportation of packages and a storage layer for storage of packages. A robot moves packages through the transportation layer to its desired location on the storage layer. The packages are moved in containers which are designed to fit the transportation layer. However, due to the use of containers to transport the packages, there is a limit of the size of the package that can be transported through the system within the container. Additionally, using containers of a fixed size is an inefficient use of space if small packages are being handled.

Some conveying systems include conveyor belts that can move parcels in all directions, known as omnidirectional conveyor belts. The conveyor belt is controlled by a control system that sends commands to a driving system. The systems often include multiple floor segments, each floor segment having a multiple omnidirectional wheels arranged within the segment. The omnidirectional wheels in each segment are connected by wires to the control system. In some cases, the segments can be lifted up out of the floor to inspect the wiring. These systems are capable of high throughput but generally do not have high precision.

Traditional e-commerce automation solutions are big, bulky, expensive, typically lacking ease of scalability and/or having restrictions with regards to exploitation of space in all three dimensions. Additionally, many of the solutions do not allow for high flexibility in run-time, with their functionality parameters often set in stone by the specific hardware configuration, leaving little room for on-demand operation adjustment and optimization.

It would be desirable to have a flexible, modular hardware system that allows for operation in at least two dimensions, and preferably in three dimensions, powered by software that allows for on demand adjustment and optimization of functionality.

### SUMMARY

According to a first aspect there is provided a conveying system for conveying objects comprising a plurality of conveyor modules. Each conveyor module comprises at least one rotatable element comprising an engagement surface configured to engage with a surface of an object to be conveyed, a driving mechanism configured to rotate the at least one rotatable element such that rotation of the at least one rotatable element causes rotation of the engagement surface and thereby movement of the object, and a control mechanism configured to control rotation of the rotatable element via the driving mechanism. The conveying system for conveying objects also comprises a conveying frame comprising a plurality of apertures, each aperture configured to receive a conveyor module so as to form an array of conveyor modules that together provide a substantially planar surface for conveying objects thereon and a control system configured to communication with the control mechanism of the conveyor module. Each conveyor module is configured to be releasably mounted within an aperture. By mounting a conveyor module within an aperture, an electrical connection between the control mechanism and the control system is established, which facilitates electrical communication between the control system and the mounted conveyor module.

The conveyor module can simply be inserted into the conveying frame without having to use any screws or other fixings to retain the conveyor module in place. Similarly, the conveyor module can simply be removed from the conveying frame by lifting it out of the conveying frame, without having to undo any fixings. Each conveyor module is compact, simple in its design, and allows for easy placement and removal from the conveying frame. Each conveyor module comprises an integrated gear based power transmission system, which helps provide a compact conveyor module.

The conveying system for conveying objects provides the ability to move objects of any size, move objects freely in any direction, and move several objects simultaneously, in different directions and without any restrictions on how many objects can be moved at the same time.

Preferably the rotatable element is an omnidirectional wheel. This provides active driven movement in a first and second direction, the first and second directions opposite to each other for example forwards and reverse directions. The omnidirectional wheel also provides passive movement in a third and fourth direction, the third and fourth direction opposite to each other and perpendicular to the first and second directions for example left and right directions. Omnidirectional wheels provide a convenient mechanism for providing motion in multiple directions, including perpendicular directions, which reduces the overall number of components present in the conveyor module.

In some examples, the at least one rotatable element may comprise an aperture having a shape that is configured to interlock with a shaft of the driving mechanism. Having a rotatable element that interlocks with a driving shaft may allow the rotatable element to be fixedly mounted to the shaft through the interlocking mechanism alone, rather than additional fixing components. This helps reduce the complexity of the conveyor module. In addition, the rotatable element may engage with a shaft of the driving mechanism such that rotation of the shaft automatically causes rotation of the rotatable element.

The aperture preferably has a cross-section comprising a plurality of recesses or indentations that are configured to engage, for example in an interlocking manner, with corresponding ridges or protrusions on the shaft of the driving mechanism.

The plurality of recesses may be equally spaced around the circumference of the aperture. Preferably, there are two or more recesses. In some developments, the aperture may have a cross-section comprising four recesses. In this case, the aperture may be considered to be cross-shaped aperture and preferably the corresponding shaft comprises four ridges having a cross-shaped cross-sectional profile. In other developments, the aperture may comprise five recesses, and so the aperture may be considered to have a star-shaped profile configured to engage with a shaft having a corresponding start-shaped cross-sectional profile. As will be appreciated, any number of recesses and corresponding ridges may be used, for example, two, three, six, or seven or more. An aperture comprising a plurality of recesses and a shaft comprising corresponding ridges provide a simple but effective means of providing the required interlocking engagement between the rotatable element and the shaft to couple them together.

The driving mechanism may comprise a motor. The motor may comprise an engaging means configured to retain the motor in place within the conveyor module. This may prevent the motor from moving laterally within the conveyor module.

The engaging means may comprise a plurality of protrusions extending from the motor. The protrusions may be configured to engage with corresponding recesses within the conveyor module. The protrusions may be located substantially opposite each other, located around a circumference of the motor.

Preferably, the conveyor module may comprise a through passageway extending between a first opening in the top of the conveyor module and second opening in the base of the conveyor module. The through passageway may pass completely through the conveyor module. The through passageway may allow water, dust, or other debris to pass through the conveyor module so that water and/or debris does not build up within the conveyor module.

In some examples, the at least one rotatable element is at least partially located within the through passageway. This may allow any water and/or debris that has collected on the rotatable element to pass through the conveyor module via the through passageway.

Preferably, the though passageway is arranged to allow fluid or objects to pass through the through passageway from the first opening to the second opening under the action of gravity. The through passageway may be orientated substantially vertically when the conveyor module is held in its operative configuration. This provides a passive drainage system within the conveyor module and so may allow for water and debris to be removed from the conveyor module without the need for an active drainage or removal system.

Preferably, the control mechanism comprises a printed circuit board (PCB). A PCB may facilitate electrical connections without the need for wires. This may facilitate easy assembly of the conveyor module.

In some examples, the conveyor module may comprise a housing configured to at least partially house the at least one rotatable element, the control mechanism, and the driving mechanism. The housing may act as a full enclosure which isolates the internal components from water and dust.

In some examples, a portion of the control mechanism may extend beyond the housing. This may facilitate easy access to the control mechanism for electrical connections.

Preferably, the portion of the control system is arranged to engage with the control system of the conveying frame. This provides an easy mechanism for electrically connecting the conveyor module to the conveying frame, without the need for wires.

The conveying frame may comprise a baseplate. The baseplate may provide a structure onto which other components may be attached.

The baseplate may comprise a first slot configured to receive the portion of the control mechanism. The baseplate may comprise a second slot configured to receive a portion of the through passageway. The slots may ensure that the conveyor module has engaged with the conveying frame, through engagement of the portion of the control mechanism and/or the portion of the through passageway with the baseplate of the conveying frame. This may help ensure that the conveyor module is securely inserted into the conveying frame, and may help prevent unwanted lateral movement of the conveyor module within the conveying frame.

Preferably, the portion of the through passageway extends further away from the housing than the portion of the control mechanism. This may have the effect that when the conveyor module is inserted into the conveying frame, the second slot receives the portion of the through passageway before the first slot receives the portion of the control mechanism. This may ensure that the conveyor module is correctly aligned within the aperture, before the electrical connection between the conveyor module and the conveying frame is made via the portion of the control mechanism. This may ensure a stable electrical connection is made between the conveyor module and the conveying frame.

The housing may comprises a plurality of flanges. The plurality of flanges may be configured to engage with the conveying frame. The flanges may be located substantially opposite each other. The flanges may allow the conveyor module to rest on a portion of the conveying frame, and so the flanges may help support the conveyor module within the conveying frame. The flanges may help ensure that the conveyor module is not inserted too far into the conveying frame.

In some examples, the housing may comprise a track extending around the perimeter of the housing. The track may be configured to receive a length of elastically deformable material. The material may help provide a snug fit between the conveyor module and the conveying frame when the conveyor module is inserted into the conveying frame. This may prevent the conveyor module moving around within an aperture of the conveying frame, which may disrupt electrical connections.

The conveyor module preferably comprises at least one magnetic portion. The magnetic portion may allow the conveyor module to be handled, for example picked up and moved around, by an electromagnetic, This may provide a simple and convenient mechanism for inserting and removing a conveyor module from a conveying frame.

To facilitate contact between an electromagnet and the conveyor module, the magnetic portion is preferably located on an external surface of the conveyor module, and preferably a surface of the conveyor module that remains exposed when the conveyor module is inserted into the conveying frame. Thus, preferably, the magnetic portion is located on an upper external surface of the conveyor module.

The magnetic portion may comprise any suitable magnetic material, for example iron, steel, or nickel.

More than one magnetic portion may be present on the conveyor module. For example two or more magnetic portions. The magnetic portions may also be referred to as magnetic contact points. Providing more than one magnetic contact point may help provide a stable connection between the electromagnet and the conveyor module. This may reduce unwanted movement between the electromagnet and the conveyor module when the electromagnet is handling the conveyor module. As will be appreciated, any suitable number of magnetic portions may be present for example four or more magnetic portions. The plurality of magnetic portions may be spaced apart around the perimeter of the top lid 8. In some cases the plurality of magnetic portions may be equally spaced apart from each other. In other cases, the plurality of magnetic portions may be randomly spaced apart from each other.

In some examples, the one or more magnetic portion may take the form of a metal plate. In other examples, the one or more magnetic contact may take the form of at least one screw that may be at least partially screwed into the conveyor module. However, as will be appreciated, any other suitable means for incorporating a magnetic portion into the conveyor module may be used.

According to another aspect there is provided a conveyor module for a conveying system for conveying objects, the conveyor module comprising: at least one rotatable element comprising an engagement surface configured to engage with a surface of an object to be conveyed; a driving mechanism configured to rotate the at least one rotatable element such that rotation of the at least one rotatable element causes rotation of the engagement surface and thereby movement of the object, and a control mechanism configured to control rotation of the rotatable element via the driving mechanism; wherein the conveyor module is configured to be releasably mounted within an aperture of a conveying frame; and wherein mounting the conveyor module within an aperture establishes an electrical connection between the control mechanism of the conveyor module and a control system of the conveying frame, which facilitates electrical communication between the conveying frame and the conveyor module.

According to another aspect there is provided a conveying frame for a conveying system for conveying objects, the conveying frame comprising: a plurality of apertures, each aperture configured to receive a conveyor module as described above so as to form an array of conveyor modules that together provide a substantially planar surface for conveying objects thereon; a control system configured to communication with a control mechanism of the conveyor module; wherein each aperture is configured to have a conveyor module releasably mounted within the aperture; and wherein mounting a conveyor module within an aperture establishes an electrical connection between the control mechanism of the conveyor module and the control system of the conveying frame, which facilitates electrical communication between the control system and the conveyor module.

According to another aspect there is provided a planning system for planning the movement of an object. The planning system comprises an information acquisition system configured to obtain object information, wherein the object information comprises a destination location of the object, and a processing system configured to determine a route of the object from the scanning location to the destination location. The planning system also comprises a main control system configured to communicate with a conveying system for conveying objects as described above, wherein the main control system is configured to control the driving mechanism of the conveyor module such that the object is moved across the substantially planar surface along the determined path from the scanning location to the destination location through rotation of the rotatable elements.

The system provides a highly modular and intelligent approach to designing and implementing sorting, storage and transportation solutions for use in e-commerce and logistics related facilities and operations. The system can be used to automate several operations present in warehouses, distribution centers and other similar facilities. The modular design of hardware, combined with intelligent automation software allows for great scalability and easy adaptation of functionality typically not present in traditional e-commerce and logistics automation solutions.

The system provides a modular hardware platform that uses a system of omnidirectional transporting surfaces to move objects freely in any direction while operating efficiently with fewer restrictions on object size. Combined with a smart software system that has full control of the hardware platform the resulting system can be adjusted in use, optimizing for varying demand in functionality, for example throughput of different operations in relationship to one another over time.

The planning system provides a smart, modular sorting, storage and transport system using a flexible omnidirectional transporting surface that allows precise movement of multiple objects across the transporting surface.

Optionally, the planning system comprises an elevator module, configured to raise and lower at least part of a transporting surface. The inclusion of an elevator module allows operation in three dimensions.

### BRIEF DESCRIPTION OF DRAWINGS

Embodiments of the present invention will now be described by way of example only with reference to the accompany drawings in which:

FIG. 1 shows a perspective view of a conveyor module;

FIG. 2 shows a part-cross sectional view of a conveyor module;

FIG. 3 shows a perspective view of a conveyor module;

FIG. 4 shows a part cross-sectional view of a conveyor module;

FIG. 5 shows a perspective view of a conveyor module;

FIG. 6 shows a cross-sectional view of a conveyor module;

FIG. 7 shows a cross-sectional view of a conveyor module;

FIG. 8 shows a perspective view of a conveying frame;

FIG. 9 shows a perspective view of part of a conveying frame;

FIG. 10 shows a top down view of part of a conveying frame;

FIG. 11 shows a perspective view of a conveying frame;

FIG. 12 shows a perspective view of part of a conveying frame;

FIG. 13 shows a perspective view of a conveying frame and conveyor module;

FIG. 14 shows a perspective view of a conveying frame and conveyor module;

FIG. 14a shows a top down view of a conveying frame and conveyor modules;

FIG. 14b shows a cross-sectional view of a conveying frame and conveyor module;

FIG. 14c shows a cross-sectional view of a conveying frame and conveyor module;

FIG. 15 shows a perspective view of a conveying frame and conveyor modules;

FIG. 16 shows a perspective view of a conveying frame and conveyor modules;

FIG. 17 shows a schematic view of conveyor modules and an object; and

FIG. 18 shows a perspective view of a conveyor module.

### DETAILED DESCRIPTION

The present disclosure relates to a conveying system for moving an object around on a surface of the conveying system. In the following description, a package will be used as an example of a type of object that may be moved using the conveying system. Generally, the conveying system comprises a plurality of conveyor modules and a conveying frame. Each conveying module comprises at least one rotatable element having an engagement surface that is configured to engage with a surface of a package. Each conveying module also has a driving mechanism configured to rotate the at least one rotatable element. In this way, rotation of the at least one rotatable element causes rotation of the engagement surface and thereby effects movement of the package on the engagement surface. A control mechanism of the conveying module is configured to control rotation of the rotatable element via the driving mechanism, and communicate with a control system which is generally external to the conveyor module. The conveying frame comprises a plurality of apertures. Each aperture is configured to receive a conveyor module so as to form an array of conveyor modules. Together, the array of conveyor modules provide a substantially planar surface for conveying packages. Each conveyor module is configured to be releasably mounted within an aperture of the conveying frame. By mounting a conveyor module within an aperture, an electrical connection between the conveyor module and the control system is established, thus facilitating electrical communication between the control system and the mounted conveyor module.

In use, a package resting on the engagement surface of the conveyor module is moved across the substantially planar surface created, through rotation of the rotatable elements so that the package is moved from an engagement surface of one conveyor module to an engagement surface of an adjacent conveyor module. This has the effect that the package is moved across the substantially planar surface.

The particular path travelled by the package across the substantially planar surface is determined and controlled by a main communication and control system, which may be referred to as a planning system. This planning system tracks and plans the movement of a package across the substantially planar surface.

Further details of the conveying system and the planning system will now be described.

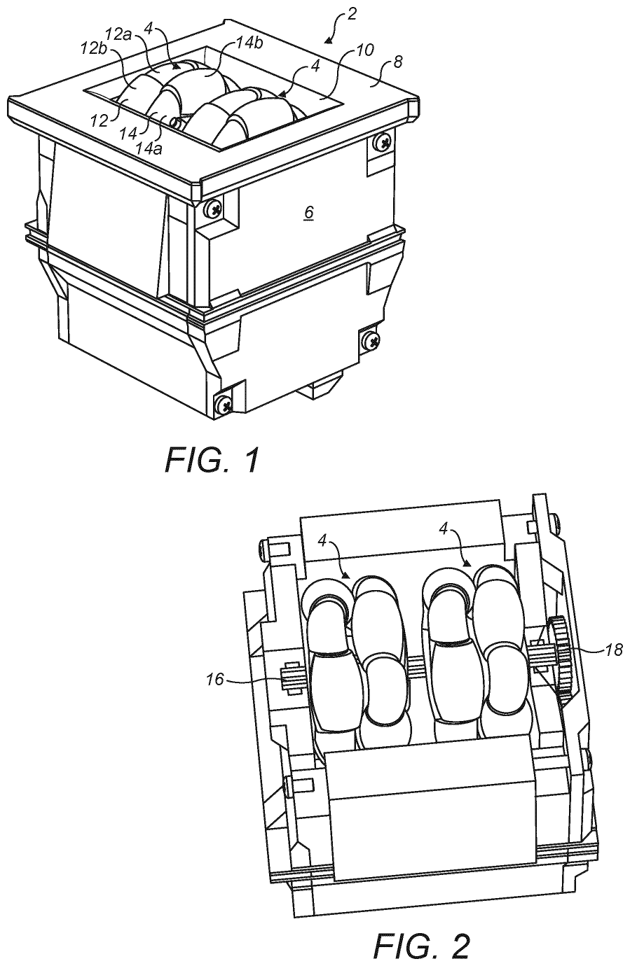

Looking first at the conveyor module, FIG. 1 shows an exemplary conveyor module 2. The conveyor module 2 may be referred to as a motorised wheel system (MWS). Generally, the conveyor module 2 is a singular unit that includes rotatable elements in the form of two actuated omnidirectional wheels 4. These wheels 4 allow a force to be applied on a package in one direction while also allowing a package to passively roll over the omnidirectional wheels 4 in the perpendicular direction.

In more detail, the conveyor module 2 includes a housing 6, made up of a number of side plates and having a generally cuboid shape, and a top lid 8. The top lid 8 comprises an aperture 10 through which a portion of each of the omnidirectional wheels 4 protrudes, as shown in FIG. 1.

Each omnidirectional wheel 4 comprises a pair of sub-wheels 12, 14 which cooperate together to act as a single wheel. Each sub-wheel 12, 14 comprises a plurality of fixed segments 12a, 14a and moveable segments 12b, 14b. The plurality of fixed segments 12a, 14a and moveable segments 12b, 14b make up the outer circumference of each sub-wheel 12, 14. In particular, the fixed segments 12a, 14a and moveable segments 12b, 14b are arranged around each sub-wheel 12, 14 such that they are spaced apart from each and so that they alternate with each other. In other words, a fixed segment 12a is circumferentially adjacent (i.e. located between) two moveable segments 12b, and similarly a moveable segment 12b is circumferentially adjacent (i.e. located between) two fixed segments 12a.

The portion of outer circumference of each sub-wheel 12, 14 which protrudes through the aperture 10 in the top lid forms part of an engagement surface. The engagement surface is the part of the conveyor module 2 onto which a package is placed and which causes movement of the package through movement of the omnidirectional wheels 4.

The fixed segments 12a, 14a fixedly rotate with the sub-wheel main body (i.e. they rotate in the direction the sub-wheel 12, 14 is driven by a motor) causing forward and backward motion. During driven motion of the omnidirectional wheel 4, the moveable segments 12b, 14b will also help effect forward and reverse motion of a package on the engagement surface. Additionally, the moveable segments 12b, 14b are able to passively rotate perpendicular to the driven direction causing sideways motion.

The two sub-wheels 12, 14 making up an omnidirectional wheel 4 are offset from each other such that a fixed segment 12a of one sub-wheel 12 is adjacent to a moveable segment 14b of the other sub-wheel 14.

As can be seen in FIG. 2, each omnidirectional wheel 4 is mounted onto an axle 16 which is connected to a driving mechanism comprising a plurality of gears 18 and a motor 20. Using the plurality of gears 18, power is transferred from the motor 20 to the axle 16 in order to drive the omnidirectional wheels 4. Bearings are provided for each gear 18 so that they can rotate freely with very little friction, resulting in efficient power transfer from the motor 20 to the omnidirectional wheels 4 as well as reducing wear.

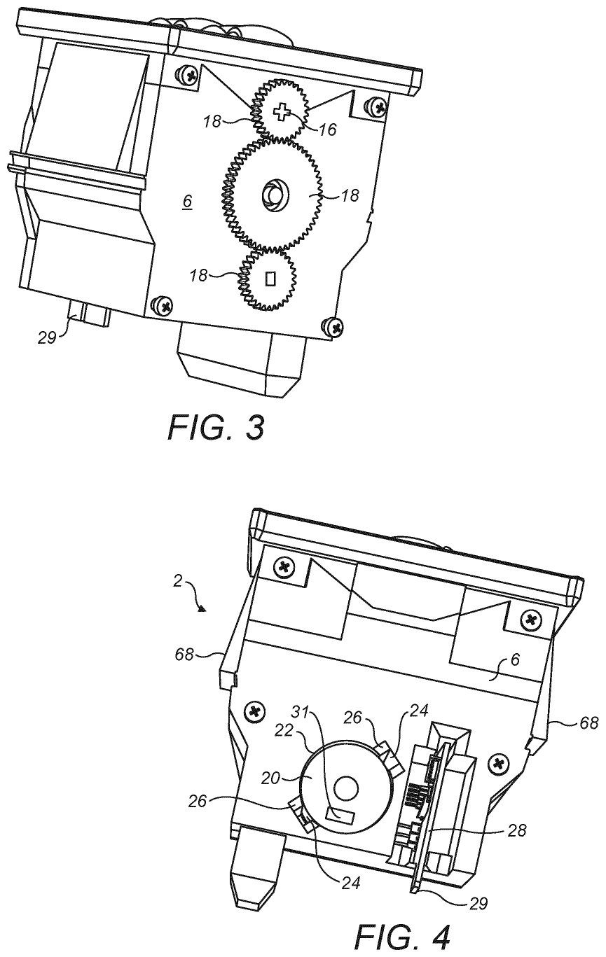

In the particular example shown in FIG. 3, the axle 16 has a cross-shaped cross section. The cross-shaped profile of the axle 16 is configured to engage, in an interlocking manner, with a correspondingly shaped hole through the main body of the omnidirectional wheels 4 when the wheels 4 are mounted onto the axle 16. As a result of the interlocking engagement between the axle 16 and the omnidirectional wheels 4, rotation of the axle 16 directly causes rotation of the omnidirectional wheels 4. However, as will be appreciated, any other suitable shape may be used for cross-sectional profile of the axle 16 and the correspondingly shaped hole through the main body of the omnidirectional wheels 4, provided that an interlocking engagement between the axle and the omnidirectional wheels is achieved. For example, both the axle and the hole through the main body of the omnidirectional wheels may have n-pointed star shaped cross sectional profiles, where n is an integer greater than 2.

The motor 20, which in this case is a DC motor, can be seen in FIG. 4. The motor 20 is contained within a channel 22 of the conveyor module housing 6. In order to prevent the motor 20 from freely rotating within this channel 22, the motor 20 comprises a pair of protrusions 24 extending radially away from the main body of the motor 20. The protrusions 24 are spaced substantially opposite each other around the circumference of the motor 20. That is, the protrusions 24 are located approximately 180 degrees from each other. The protrusions 24 are arranged to engage with a pair of correspondingly shaped slots 26 within the channel 22, in order to retain the motor 20 in place. As a result of this engagement, the motor 20 cannot rotate freely about its centre point.

Although not shown in FIGS. 3 and 4, back and side plates are provided to cover the gears 18 and the motor 20 to protect the parts of the driving mechanism from dust and damage due to external factors. In addition, the back plate helps prevent sideways movement of the motor 20 along the channel in the housing 6, and so the back plate prevents the motor 20 from falling out of the channel 22 in the housing 6.

The conveyor module 2 comprises a control mechanism 28 which takes the form of a printed circuit board (PCB), as shown in FIG. 4. The control mechanism 28 is connected to the motor 20 via a connection point 31 on the motor which provides an electrical interface between the motor 20 and the control mechanism 28. The control mechanism 28 controls the rotation of the omnidirectional wheels 4 via the motor 20 and gears 18.

The control mechanism 28 is also arranged to communicate with a control system that is external to the conveyor module 2, typically part of the conveying frame. In this way, the control mechanism 28 can receive commands from the control system and control the motor 20 accordingly. This will be explained in more detail later.

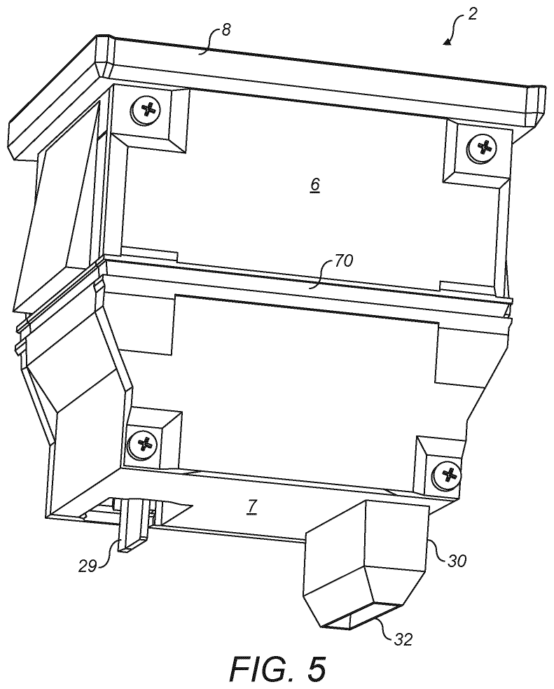

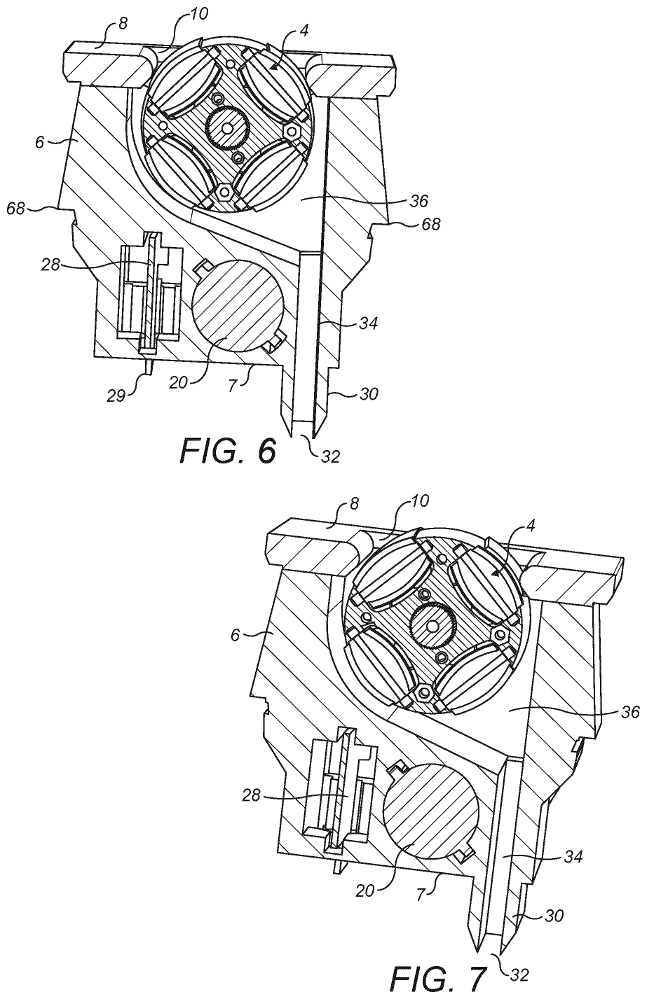

As illustrated in FIG. 5, the housing 6 of the conveyor module 2 comprises a chute 30 projecting away from the main body of the conveyor module 2 from the bottom 7 of the housing 6. Here, the bottom 7 of the housing 6 corresponds to the part of the housing 6 opposite the top lid 8. Details of the chute 30 can be more clearly seen in FIGS. 6 and 7.

The chute 30 comprises a passageway 34 which extends into the main body of the conveyor module 2 to a chamber 36 in which the omnidirectional wheels 4 are located to allow them to rotate freely. The chamber 36 fluidly connects with the aperture 10 in the top lid 8 of the conveyor module 2. The chute 30 acts as a water and dust drainage system, allowing dust and water which enters the aperture 10 to flow through the chamber 36 and passageway 34, and out of the chute 30 via an opening 32. In use, the passageway 34 of the conveyor module 2 will be substantially vertical. This has the advantage that any debris collected in the chamber 36 is able to flow downwards through the passageway 34, under the action of gravity, and out the opening 32 in the chute 30. This avoids debris, in particular water and dust, building up within the chamber 36, or space, which surrounds the omnidirectional wheels 4 which could affect rotational movement of the wheels 4. The conveyor module 2 can therefore be thought of as comprising a through passageway which extends between a first opening at the top of the conveyor module 2 (i.e. the aperture 10 in the top lid 8) and a second opening at the base of the conveyor module (i.e. the opening 32 of the chute 30). The omnidirectional wheels 4 are located at least partially within this through passageway.

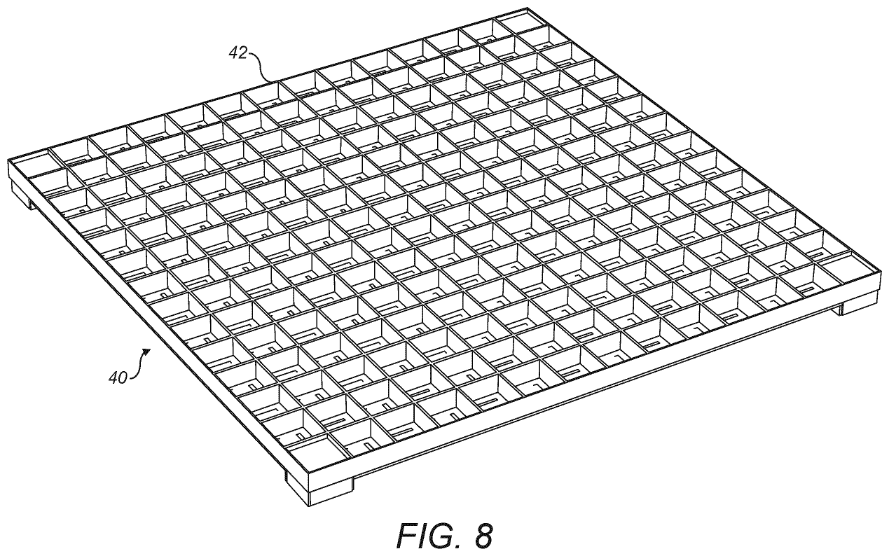

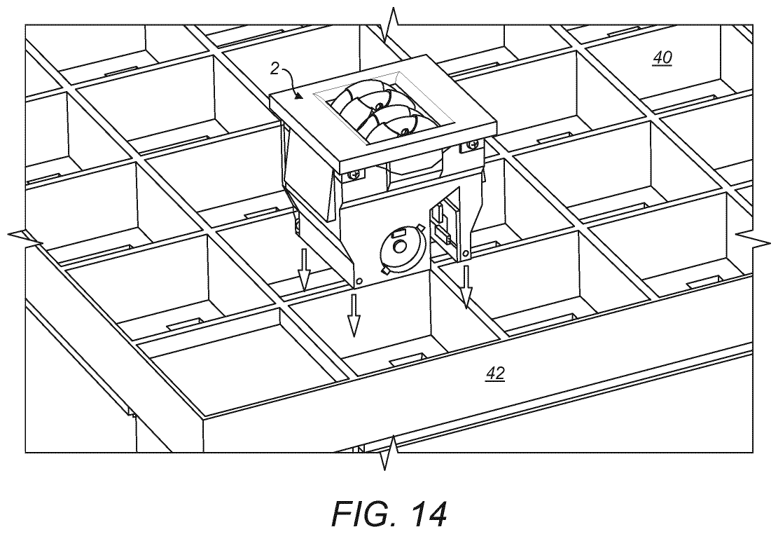

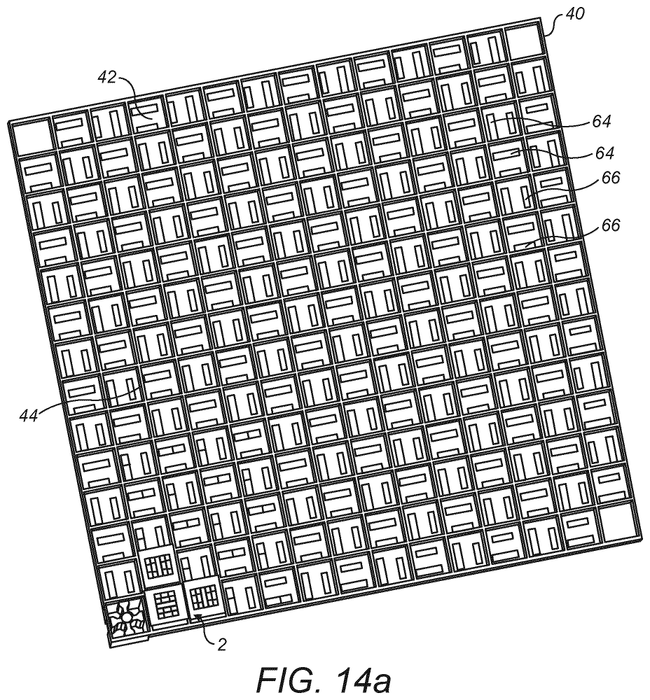

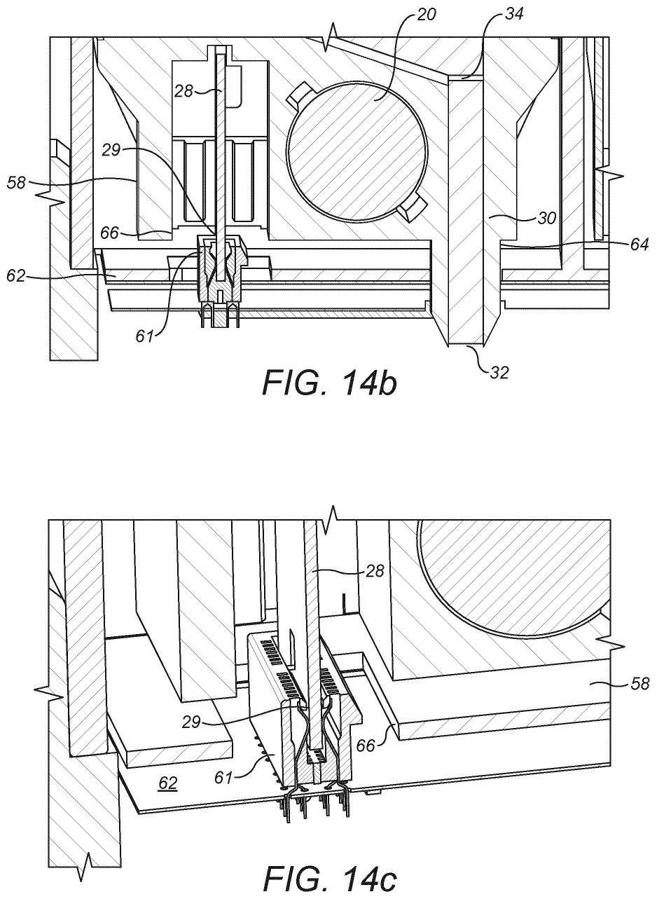

Turning now to FIG. 8, an exemplary conveying frame 40 is shown in the form of a metal grid frame. The conveying frame 40 comprises a plurality of apertures 42, regularly arranged in a grid-like manner across the conveying frame 40. The apertures 42 of the conveying frame 40 are each for receiving a conveyor module 2 as illustrated in FIG. 14, forming an array of conveyor modules 2 that together form a conveying surface for transporting packages received on this surface. The conveying frame 40 therefore acts as a support structure for holding many conveying modules 2 together in order to form a transport surface over which packages can be transported.

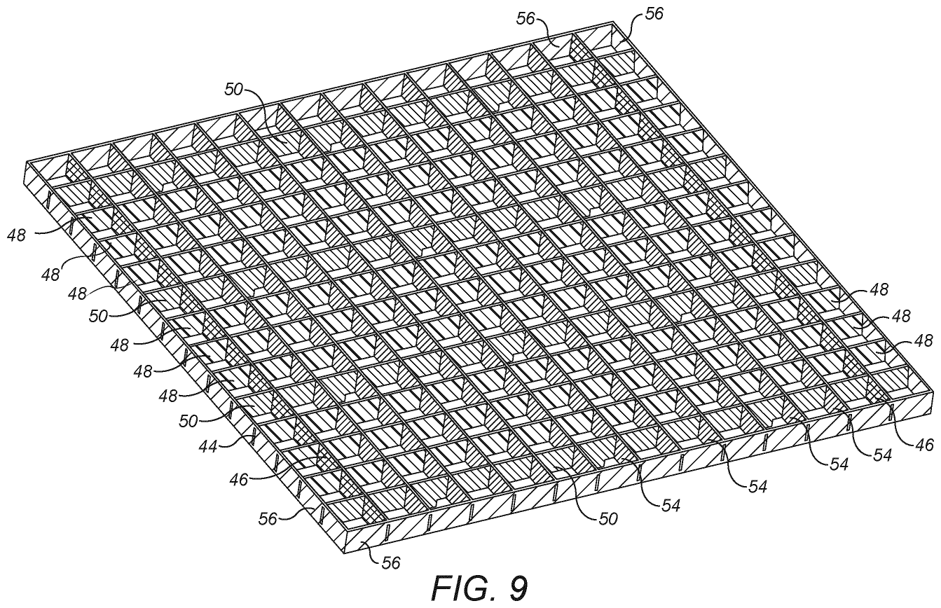

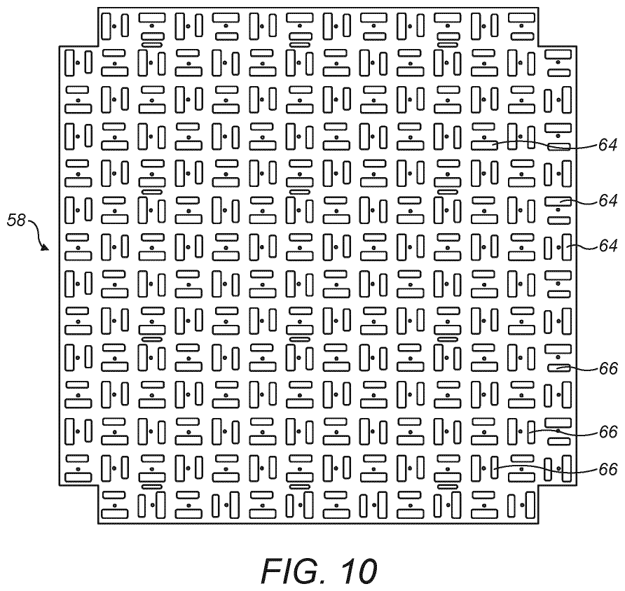

The conveying frame 40 comprises a framework 44, shown in FIG. 9, and a baseplate 58, shown in FIG. 10.

The framework 44 comprises two support plates 46, positioned substantially parallel to each other and spaced apart from each other. The support plates 46 are located adjacent and parallel to two side edges of the framework 44, as shown in FIG. 9. The support plates 46 are made of stainless steel in order that these support plates 46 are sufficiently strong to be able to withstand the weight of the conveying system.

The framework also comprises a plurality of primary inner plates 48, positioned substantially parallel to each other and spaced apart from each other. The primary inner plates 48 are generally perpendicular to the support plates 46, and extend across the middle area of the framework, as shown in FIG. 9. The support plates 46 may be made of aluminium.

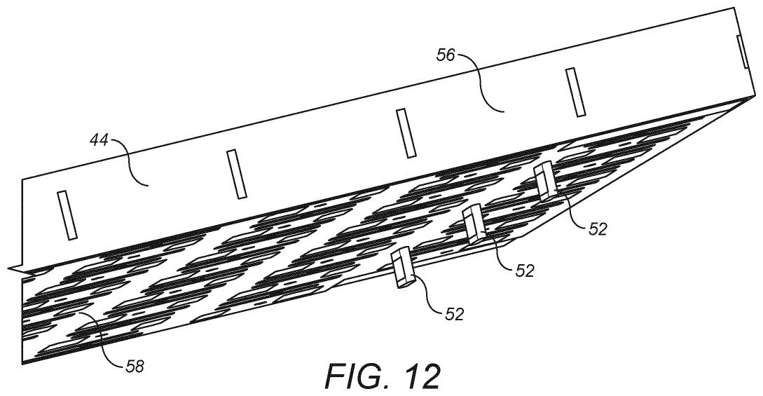

A plurality of connector plates 50 are positioned substantially parallel to each other and spaced apart from each other, acting to separate the plurality of inner plates 48 into a number of sub-groups, as shown in FIG. 9. The connector plates 50 are parallel to the inner plates 48 and perpendicular to the support plates 46. The connector plates 50 may be made of aluminium. Each connector plate 50 comprises a plurality of connector legs 52, extending away from the framework 44 underneath the framework 44, as shown in FIG. 12.

In order to complete the grid-like framework 44, a plurality of secondary inner plates 54 are positioned substantially parallel to the support plates 46, extending across the inner area of the framework 44. The secondary inner plates 54 are perpendicular to the primary inner plates 48 and the connector plates 50. The secondary inner plates 54 may be made of aluminium.

Finally, four edging plates 56 are placed around the outer edge of the framework 44 forming the outer boundary of the framework 44, as shown in FIG. 9. The edging plates 56 may be made of aluminium.

All the plates of the framework are connected together using a plurality of slots within each plate. Thus, one plate is slotted into another plate forming an intersection. In particular, the plates are arranged to slot into each other under the action of gravity, and so the framework 44 can be held together under the action of gravity rather than physical fixing components. In the example shown in FIG. 9, the constructed framework 44 forms a grid having 14×14 apertures 42, where each aperture 42 is a square of size 83 mm×83 mm. However, alternative framework sizes are also possible.

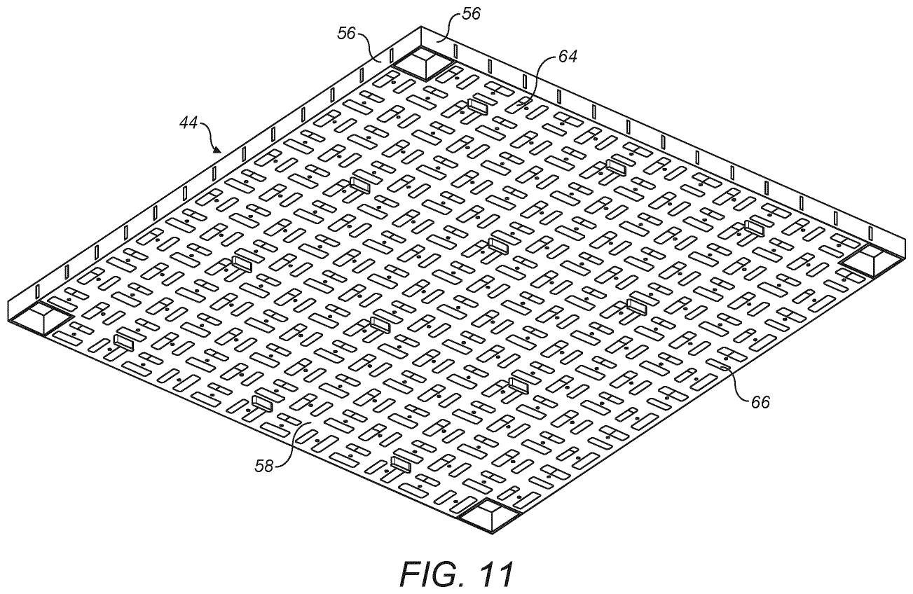

Once the framework 44 has been constructed, the baseplate 58 is attached to the underside of the framework 44, as shown in FIG. 11. When the baseplate 58 is attached to the framework 44, the connector legs 52 extend through corresponding slots in the baseplate 58 as shown in FIG. 12. In order to improve the structural integrity of the conveying frame 40, the baseplate 58 can be welded to the framework 44, for example using point welding.

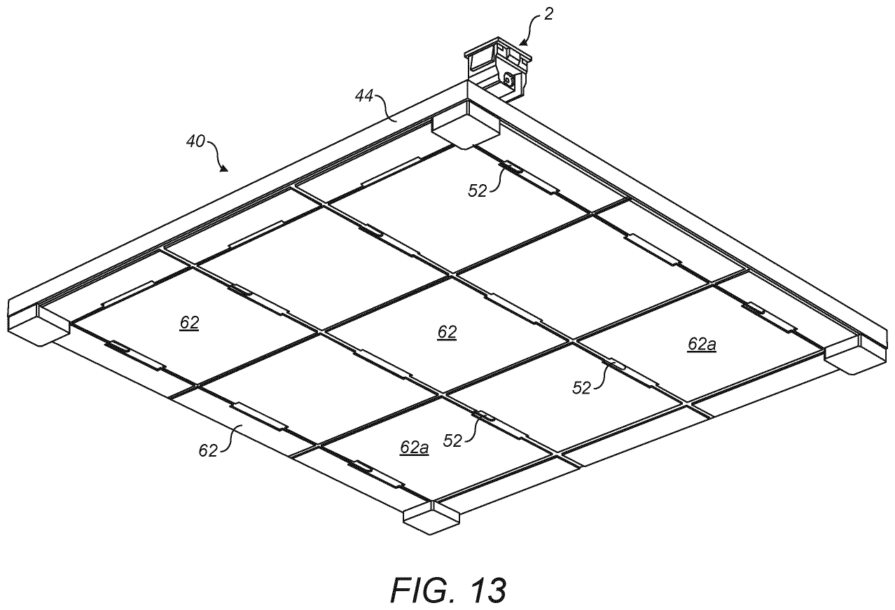

A control system 60 is arranged to communication with a main control system as well as each conveyor module 2. The control system 60 forms part of the conveying frame 40 and takes the form of a PCB system comprising a plurality of PCBs 62, as shown in FIG. 13. The PCBs 62, which may also be referred to as Mod-PCBs (module PCBs), come in two general forms. A first form may be referred to as a large PCB 62a, and comprises a PCB having an area sized to cover 4×4 apertures 42 in the conveying frame 40. A second form may be referred to as a small PCB 62b, and comprises a PCB having an area sized to cover 1×4 apertures 42 in the conveying frame 40. The different forms are required due to the shape of the baseplate 58, which can be seen more clearly in FIG. 10. Although the baseplate 58 is generally square in shape, there is a void or empty space at each corner of the baseplate 58. As such, the large PCBs 62a are used to cover a main square area of the baseplate 58 while the small PCBs 62b are used to cover each of the four shorter outer edge areas of the baseplate 58, as shown in FIG. 13. Thus, the two different PCB forms perform the same function. However, their different structure ensures the baseplate 58 is fully covered by the control system 60. This arrangement of PCBs 62 is an efficient way of covering the whole are of the baseplate 58 whilst using as few different forms and as few individual PCBs as possible. The multiple PCBs 62 are connected together using wires. In the illustrated example, the wires are threaded through the connector legs 52, which are in the form of a ring, in order to ensure the wires are kept tidy and out of the way. However, in other examples not illustrated, the wires may be arranged in another way, for example the wires may be placed in channels.

The control system 60 is connected to a main power supply located underneath the conveying frame 40. In particular, each PCB 62 comprises a power inlet connected to a power supply unit (PSU). Thus, there is one PSU for each conveying frame 40.

As mentioned previously, each conveyor module 2 is designed to be inserted into an aperture 42 in the conveying frame 40, as shown in FIG. 14, in order to form a transporting surface made up of multiple conveyor modules 2. Since each conveyor module 2 is identical, forming the transporting surface using multiple, identical conveyor modules 2 reduces overall production costs. In addition, since all the omnidirectional wheels 4 within each conveyor module 2 are pointing in the same direction, and each conveyor module 2 has only one motor 20 to drive the wheels 4, each conveyor module 2 is relatively cheap to produce.

In particular, the conveyor module 2 is designed to be easily inserted into an aperture and removed from the aperture 42. In other words, there are no fixed or permanent connections between the conveyor module 2 and the conveying frame 40. Instead the conveyor module 2 can be inserted into an aperture 42 when it is need and subsequently removed from the aperture 42 either when it is not needed or for replacement or repair. In this way, the conveyor module 2 can be thought of as being releasably mounted within the aperture 42 rather than fixedly mounted within the aperture 42. The ability to insert and remove the conveyor module 2 as and when needed may be referred to as “Plug-and-Play”.

The conveyor module 2 is designed such that when the conveyor module 2 is inserted into an aperture 42 of the conveying frame 40, the control mechanism 28 of the conveyor module 2 will automatically connect with the control system 60, in particular the PCB 62, of the conveying frame 40. This therefore has the effect that when the conveyor module 2 is inserted into an aperture 42 of the conveying frame 40, the control mechanism 28 of the conveyor module 2 will automatically connect with the main control system, via the connection with the control system 60 of the conveying frame 40.

Automatically establishing an electrical connection between the conveying module 2 and the conveying frame 40 upon insertion of the conveyor module 2 into the conveying frame 40 means that an electrical connection is automatically established between the conveying module 2 and the main control system upon insertion of the conveyor module 2 into the conveying frame 40.

Each PCB 62 on the underside of the conveying frame 40 is connected to a plurality of conveyor modules 2 above the PCB 62 as well as being connected to the main power supply and control systems below the PCB 62. In this way, each conveyor module 2 is connected to the main power supply and control system via the PCBs 62 of the conveying frame 40.

Due to the design of the conveyor module 2, and the provision of a large PCB 62 for connection and power supply on the underside of the conveying frame 40, each conveyor module 2 can be simply “dropped” into an aperture 42 of the conveying frame 40 and the conveyor module 2 will connect its own control mechanism, in the form of a PCB, to the central control system. This “plug and play” mounting system makes it possible to change a conveyor module 2 very quickly should the existing one malfunction, thus decreasing the cost of maintenance.

A number of features which facilitate the plug-and-play solution will now be discussed.

As can be seen in any of at least FIGS. 3-7, the control mechanism 28 comprises a portion 29 which extends beyond the housing 6 of the conveyor module 2. The chute 30 also extends beyond the main housing 6 of the conveyor module 2.

As can be seen in FIG. 14a each aperture 42 comprises two slots, namely a primary slot 64 and a secondary slot 66. Both the primary and secondary slots 64, 66 are substantially rectangular in shape. Generally, the primary slot 64 is larger than the secondary slot 66. The primary and secondary slots 64, 66 in each aperture correspond to the slots 64, 66 in the baseplate 58 as shown in FIG. 10.

When the conveyor module 2 is inserted into the aperture 42, the extending portion 29 of the control mechanism 28 is arranged to be inserted into the secondary slot 66 in the baseplate 58, as can be seen in FIG. 14c. In particular, each extending portion 29 of the control mechanism 28 of the conveyor module 2 is received by a PCI connection interface 61 on the PCB 62 of the conveying frame 40. The extending portion 29 slots into the female PCI connector 61 which extends upwards from the PCB 62 mounted below the baseplate 58 and extends towards the conveyor module 2. When the conveyor module 2 is inserted into the aperture 42, the extending portion 29 slides into the PCI connector 61 on the PCB 62, thus connecting the control mechanism 28 of the conveyor module 2 to the control system 60 of the conveying frame 40.

The use of a control mechanism 28 in the form of a PCB on the conveyor module 2 and a corresponding PCB 62 and PCI 61 connection on the conveying frame 40 provides the ability to control and power each conveyor module 2 independently from each other. The use of PCBs rather than a wire-based system results in a more compact system and a quicker assembly process. Furthermore, maintenance of both the conveyor module 2 and the conveying frame 40 is much simpler because the conveyor module 2 can be simply lifted out of its corresponding aperture 42 in the conveying frame 40, without the need to undo lots of wiring.

In addition, when the conveyor module 2 is inserted into the aperture 42, the chute 30 is arranged to be inserted into the primary slot 64 in the baseplate 58 as can be seen in FIG. 14b. This is important because the chute 30, which extends through the baseplate 58, acts to anchor the conveyor module 2 into the aperture 42 of the conveying frame 40. In particular, the chute 30 helps to correctly align the conveyor module 2 within the aperture 42 which helps ensure correct alignment of the extending portion 29 with the PCI connection 61 on the PCB 62. In particular, as the chute 30 extends further away from the housing 6 than the extending portion 29, when the conveyor module 2 is inserted into the aperture 42, the chute 30 is inserted into the primary slot 64 in the baseplate first to ensure correct alignment. As the conveyor module 2 is further inserted into the aperture 42, the extending portion 29 then connects with the PCB 62 of the conveying frame 40.

By having the chute 30 inserted into the baseplate 58 before the extending portion 29, correct positioning of the conveyor module 2 within the aperture 42 is achieved before the electrical connection with the conveying frame 40 and main control system is made. This reduces the chance of damaging electrical components during insertion of the conveyor module 2, as well as ensure a good electrical connection is made. The primary slot 64 in the baseplate may therefore be thought of as an alignment slot 64 and the secondary slot 66 may be thought of as a connection slot 66.

As can be seen in FIG. 14b, the chute 30 also extends through a corresponding slot in the PCB 62, and so the opening 32 passes through the PCB 62. This is necessary because the function of the chute 30 is to allow dust and water to drain from inside the housing 6 of the conveyor module 2 to the outside. The chute 30 must therefore extend through the PCB 62 to ensure that the exhausted dust and water are not deposited on the PCB and do not come into contact with any of the electrical components. This is important because any water than may come into contact with the electrical components may cause short circuits, which may damage the components, and is a potential fire hazard.

To further facilitate correct placement of the conveyor module 2 within the aperture 42, the housing 6 of the conveyor module 2 is provided with a pair of flanges 68, for example as shown in FIG. 4. The flanges 68 are located substantially opposite each other on opposite sides of the housing 2. Each flange 68 extends along the length of the side of the housing 6. When the conveyor module 2 is inserted into the aperture 42, the flanges 68 abut the framework 44, preventing the conveyor module 2 from being further inserted into the aperture 42. In particular, each flange 68 rests on a top surface of a plate 46, 48, 50, 54, 56 of the framework 44. This helps ensures that the extending portion 29 of the control mechanism 28 is correctly inserted into the PCI connection 61 of the control system 60, ensuring a good electrical connection.

As the flanges 68 are only located on two opposing sides of the housing 6, rather than on all four sides, the housing 6 has a generally rectangular shape rather than a square shape. The top lid 8 is shaped to correspond to the general shape of the housing 6, and so the top lid has a generally rectangular shape. In particular, the top lid 8 is arranged to extend over the flanges 68, as shown in FIG. 6. Having a top lid 8 which extends over the flanges 68, reduces the chance of neighbouring conveyor modules 2 from getting caught on each other during insertion or removal from an aperture 42.

The conveyor module also comprises a track 70 which extends around the perimeter of the housing 6, and can partially be seen in FIG. 5. The track is located below the flanges 68. The track 70 is shaped to receive a length of elastically deformable material. The material is also flexible so that it can follow the shape of the track 70. Examples of suitable materials include foam or rubber. The material is inserted into the track 70, along the entire length of the track 70, and acts to provide a tight fit between the housing of the conveyor module 2 and the plates of the framework 44 when the conveyor module 2 has been positioned within the aperture 42. The material fills in any space between the housing 6 and the plates, preventing lateral movement of the conveyor module 2 in the aperture 42. Preventing unwanted lateral movement is important for ensuring a stable electrical connection and preventing damage of components.

In order to facilitate removal of the conveyor module 2 from the conveying frame 40, some conveyor modules 2 include at least one magnetic portion 5 as shown in FIG. 18. The magnetic portion allows a removal device comprising an electromagnet to remove the conveyor module 2 from the conveying frame 40 through interaction between the electromagnet and the at least one magnetic portion 5 on the conveyor module 2. In the example illustrated in FIG. 18, the magnetic portion 5 is located within the top lid 8 of the housing 6 of the conveyor module 2, so that the magnetic portion 5 is easily accessible by the electromagnet which facilitates handling of the conveyor module 2 by the electromagnet.

As can be seen in FIG. 18, the conveyor module 2 comprises a plurality of magnetic portions 5, in this case four magnetic portions 5. In this example, the magnetic portions 5 are located on either side of the aperture 10 of the top lid 8. Multiple magnetic contact points 5 between the conveyor module 2 and the electromagnet of the removal device facilitates stable removal of the conveyor module 2 from the conveying frame 40.

The one or more magnetic portions 5 takes the form of a metal plate located within in the top lid 8, for example within a recess in the top lid 8.

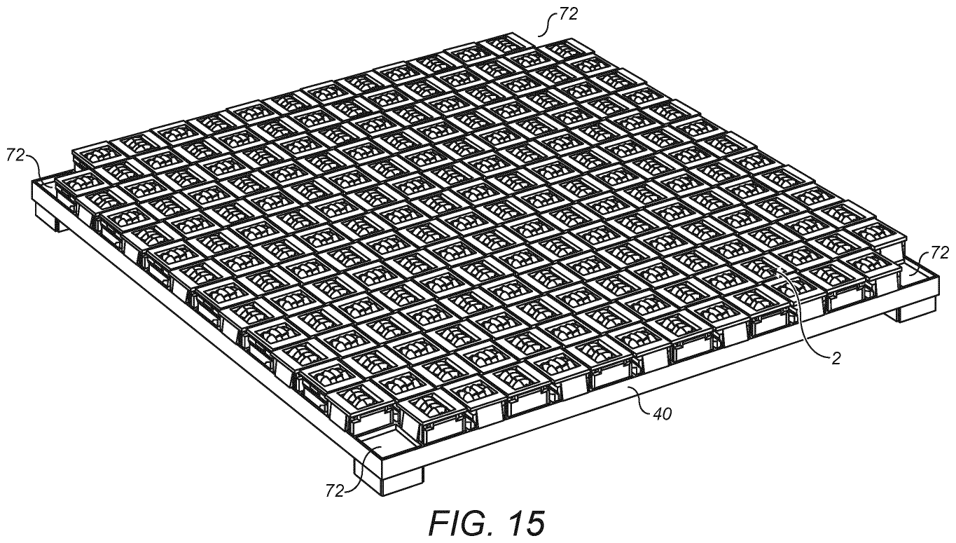

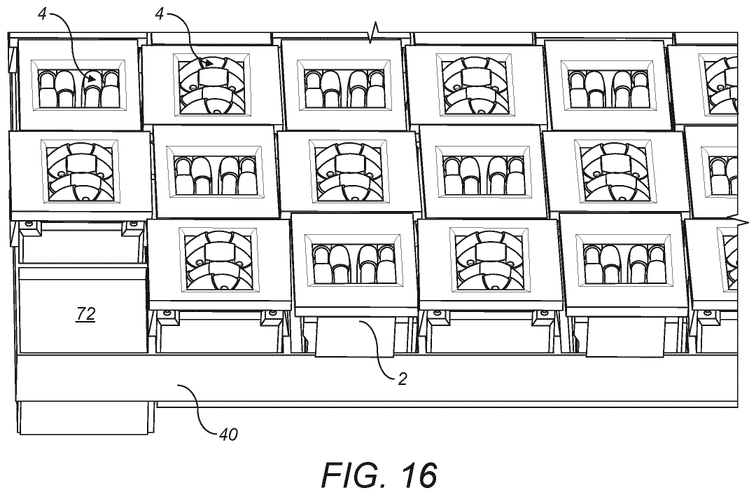

FIG. 15 shows a conveying frame 40 filled with multiple conveyor modules 2 to form a transporting or conveying surface. As can be seen in FIGS. 15 and 16, there is an empty space 72 at each corner of the conveying frame 40. The empty spaces 72 are for receiving support structures (not shown) for additional components, examples of which will be described later.

The conveyor modules 2 are inserted into the conveying frame 40 in an alternating, or chess-board-like, pattern, which can be most clearly seen in FIG. 16. By alternating we mean that when looking at the conveying frame 40 from above, the omnidirectional wheels 4 in a conveyor module 2 alternate between being arranged in a forwards-backwards driven direction and a left-right drive direction. The driven direction of the omnidirectional wheels 4 within a conveyor module 2 may be considered as a longitudinal axis of the conveyor module 2. The alternating arrangement of conveyor modules 2 therefore means that the longitudinal axis of the plurality of conveyor modules 2 alternates between being aligned at 0 degrees and aligned at 90 degrees, the angles of alignment being defined in relation to the conveying frame 40 when viewed from above. Thus, as illustrated in FIG. 16, the omnidirectional wheels that are aligned at 0 degrees may be considered as being orientated up-and-down along the conveying frame 40 and the omnidirectional wheels 4 that are aligned at 90 degrees may be considered as being orientated left-and-right across the conveying frame 40.

The arrangement of the slots 64, 66 in the baseplate 58 facilitates this alternating arrangement of conveyor modules 2. As discussed previously, and as illustrated in FIG. 10, the primary 64 and secondary 66 slots in the baseplate 58 are differently sized, as they each receive a different component of the conveyor module 2. Specifically, the primary slot 64 for receiving the chute 30 is larger than the secondary slot 66 for receiving the portion 29 of the control mechanism 28. This means that each conveyor module 2 can only be inserted into an aperture 42 in one orientation only, in order that the chute 30 and extending portion 29 can engage with the primary and secondary 64, 66 slots. As shown in FIG. 10, the slots in each aperture 42 are arranged in an alternating pattern in which the slots of one aperture are aligned with 0 degrees and the slots of an adjacent aperture are aligned with 90 degrees. This means that the conveyor modules 2 will automatically be arranged in an alternating manner when they are inserted into the conveying frame 40 as a result of the orientation of the baseplate slots 64, 66, and so it would not be possible to insert a conveyor module 2 with an incorrect orientation into the conveying frame 40.

As mentioned previously, the omnidirectional wheels 4 allow objects to be pushed forward and backward by the wheel 4, as is the case with any other wheeled device. However, the moveable segments of the wheels 4 allow objects to passively roll left and right over the wheel 4.

As a result of the use of omnidirectional wheels 4 in the conveyor modules 2, the alternating pattern of conveyor modules 2 in the conveying frame 40 can freely move any object in any direction, provided that the object is in contact with at least two omnidirectional wheels 4 that are aligned 90 degrees in relationship to each other.

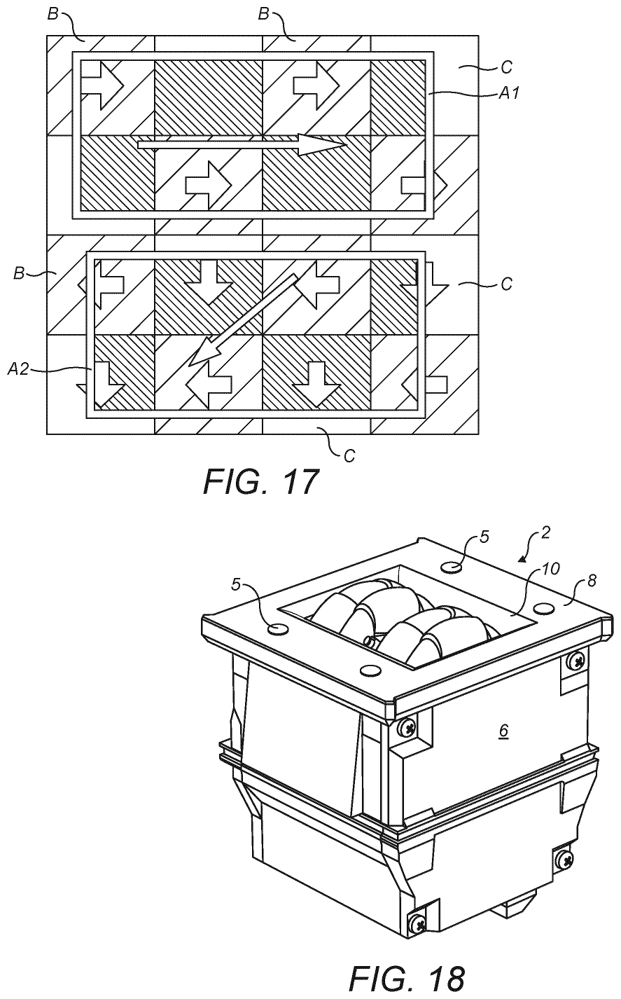

Since each conveyor module 2 can provide a driven force in one direction, when many conveyor modules 2 are arranged together, with a 90 degrees rotation alternating back and forth between adjacent conveyor modules 2, the resulting transporting surface can apply a driven force in both the x and y directions and any sum of these. For example, movement in the x direction can be achieved by only driving omnidirectional wheels 4 that “point” in the x direction and diagonal movement can be achieved by turning on all omnidirectional wheels 4 under an object. Thus, not all conveyor modules 2 need to be driven at any given time. Instead only the conveyor modules that are needed to cause movement of a package are activated. This is illustrated in FIG. 17.

FIG. 17 shows two outlines A1, A2 with represent two packages on a conveying surface. One set of squares B can apply horizontal movement (left and right across the page) while the other set of squares C in the alternating pattern can apply vertical movement (up and down along the page). The first package A1 is moved in a horizontal direction by the driven horizontal squares B, and moving passively over the vertical squares C. The second package A2 is moved in a diagonal directions as a result of the sum of the driven forces applies by both squares B and C.

The conveying frame 40 essentially acts as an omnidirectional drive, capable of controlling the omnidirectional wheels 4 of each conveyor module 2 independently from each other. That is, the movement of the omnidirectional wheels 4 of any one conveyor module 2 is independent from the movement of the omnidirectional wheels 4 of any other conveyor module 2. In other words, the omnidirectional wheels 4 do not all need to be active and in motion at the same time; only the wheels necessary to effect movement of a package need to be driven at any given time. This allows for precise and individual control of packages on the transporting surface.

The particular arrangement of conveyor modules 2 in the conveying frame 40 to form the alternating grid-like pattern means that the space between adjacent (adjacent in both the vertical and horizontal direction) conveyor modules 2 is relatively small, and so the distance between omnidirectional wheels 4 is also small. This means that there is a relatively high density of omnidirectional wheels 4 over the entire transporting surface. This leads to high movement precision as a package does not need to travel a great distance before its movement can be adjusted e.g. its direction of travel changed. Additionally, a relatively high density of conveyor modules 2, with a corresponding small distance between omnidirectional wheels 4, means that smaller packages can be moved around over the transporting surface.

Particular control of the omnidirectional wheels 4 to effect particular movement of a package on the transporting surface is ultimately undertaken by the main control system, which sends commands to the control mechanism 28 via the control system 60 of the conveying frame 40.

The control system 60 of the conveying frame 40 is connected to the main control system, which has overall control of the conveying frame 40 and conveyor modules 2 of the conveying system. The PCBs 62 of the control system 60 communicate with the main control system using an Ethernet connection. Each PCB 62 of the control system has an Ethernet cable, and the plurality of Ethernet cables are combined into a main Ethernet switch which is routed to the main control system, creating a LAN network. A LAN network and the associated Ethernet protocols are an efficient and scalable means of communicating between a central control system and the control system 60.

The control system forms part of an overall planning system. Generally, the planning system is the system which controls the movement of packages through the conveying system to ensure they reach their end destination.

The planning system includes an information acquisition system, a processing system, and a main control system. The information acquisition system is arranged to obtain package information from the package, wherein the package information comprises a destination location of the package. The processing system is configured to determine a route of the package from the scanning location to the destination location. The main control system is configured to communicate with the previously described conveying system, wherein the main control system is configured to control the driving mechanism of the conveyor module such that the package is moved across the substantially planar surface along the determined path from the scanning location to the destination location through rotation of the rotatable elements. Further details will be provided in the following.

In order to determine an end destination of each package, each package first needs to be entered into the planning system. Once the package has been entered into the system, information associated with the package can be retrieved, for examples the package ID and its end destination, and these can be used by the planning system to plan a route for the package to travel across the transporting surface to its end destination.

Thus, in order for the planning system to know what to do with each individual package, the package needs to be identified and matched with the package in the database provided by a customer. This is done by obtaining information about the package using the acquisition system. In some examples, the acquisition system takes the form of a scanning system. In this case, the scanning system scans a barcode on the package and searches for the code in the database provided by the customer.

In particular, when a new package is placed on to the system, by placing the package on the transporting surface at a starting location, it will be driven, or moved, to a scanning area by the omnidirectional wheels 4 which make up the transporting surface. Once the package reaches the scanning area, the barcode on the package is scanned. This may be done using any suitable imaging apparatus such as a barcode scanner or a camera.

The scanning system comprises a plurality of scanning apparatus, positioned at different locations and pointing in different directions. This allows the scanning system to identify and scan a barcode anywhere on the package. In particular, in the scanning area, scanning apparatus will be located above the scanning area and pointing below, in order to capture barcodes on the top of packages. Scanning apparatus will also be positioned around a horizontal perimeter and pointing inwards to the centre of the area defined by this perimeter, in order to capture barcodes on the sides of the package. Some scanning apparatus will be positioned on the transporting surface and pointing upwards, in order to capture barcodes that are on the underside of a package.

Once the barcode has been located and scanned, the planning system will then search through a database of packages provided by the customer and find the code matching the one from the barcode.

While a scanning system has been provided as an example of an information acquisition system, other systems may also be used. For example, in some cases the planning system may receive information about a new package from an external source. In this case, the information acquisition system may be a processing or computing device arranged to receive information about a package in order to identify the package and match with the package in the database provided by a customer.

After the package has been identified, the planning system can also look up the end destination of the package, using the database, so that the planning system is able to plan operations and movement of the package accordingly.

The movements of the package are determined by the processing system. The processing system includes an observation system, for observing the package and its movements, and a planning system, for determining the route the package takes across the transporting surface.

In general, the planning system uses a machine learning algorithm to determine the movement steps for all packages in the system. This has the advantage that the algorithm will optimize itself for every deployed system, taking into account the physical setup of the system (e.g. floor geometry, number of floors), the operation pattern, the number of other packages being moved, and the size and shape of the packages.

The observation system comprises a plurality of video cameras which are able to detect and track the packages as they move across the transporting surface. The plurality of video cameras are placed above the transporting surface, looking down at the transporting surface. The transporting surface of the overall system will generally be made up of multiple conveying frames located next to each other, in order to build up the shape of the desired overall transporting surface. In general there are several cameras above each transport module. The video stream from the video cameras is used by a software algorithm to look at the stream from the cameras and detect and continuously track packages in the feed.

The observation system and planning system work together, as the processing system, to route a package across the transporting surface, avoiding other packages and obstacles, to its end destination. The planning system plans a movement sequence for a package and this sequence is executed by sending appropriate commands to the conveyor modules 2 to control movement of the omnidirectional wheels 4. The planned movement sequences are determined by the mode of operation. One example mode of operation is referred to as “Sequencing”, where packages are moved around until they are sitting on the transporting surface in a desired order/sequence. This operation may be carried out before packages are taken out of the system one by one and placed in a truck so that the order of placement in the truck matches the order of unloading when the truck is driving through a delivery route.

The main control system is a general software system that uses observation data from the observation system to control the movement of packages. The control system takes in as input the desired state of each package (position and rotation) and produces a set of control commands that move the package toward its desired state. While doing this, the control system uses the run time data from the observation system in order check for errors in movement trajectory and produce adjustment commands as and when is necessary.

Each movement command is first expressed in a vector form [linear velocity, angular velocity] where each vector represents the linear and angular velocities that the package should have during the specific time step. Then, a vector field is created for each package that will, when applied as commands to the conveyor modules 2, result in the desired linear and angular velocities. Finally, the vector field is only applied to the conveyor modules 2 directly beneath the package (here, the observation data is again used to determine which conveyor modules 2 are beneath each package).

Finally, because each omnidirectional wheel 4 can only produce a horizontal or vertical force field element, the control signal sent to each conveyor module 2 represents only the vector component of the field element that is parallel to the direction of the omnidirectional wheels 4 on that particular conveyor module 2. For example, if a uniform vector field that is to be applied is [2,1], (meaning 2 in the horizontal direction and 1 in the vertical direction), a control signal of 2 is sent to all conveyor units 2 that can apply force in the horizontal direction and a control signal of 1 is sent to all conveyor units 2 that can apply force in the vertical direction. In the end, this number of the control signal is converted to actual RPM (so 2 may represent maximum RPM in clockwise direction, 1 may represent 50% of maximum RPM in clockwise direction and −2 may represent maximum RPM in counter clockwise direction).

The general steps of operating the planning system will now be briefly described.

Firstly, a package is placed on the transporting surface. This is generally done at a start location on the transporting surface. The package is then immediately imaged and detected by the observation system in order to enter the package into the overall system. The detected package is then assigned an ID so that the package can be identified and tracked within the system. The IDs are assigned so that no two packages on the transporting surface at the same time have the same ID. A “package instance” is created which contains relevant information about the package, for example its current location and its dimensions. The planning system is informed about the new package and a command to move the package is produced. The first movement command is typically to send the package to the scanning area so that the scanning system can identify the end destination of the package, using the barcode, and the planning system can subsequently plan movement of the package accordingly.

As the package moves along the transporting surface the observation system tracks the package by using the positional information from previous time frame captured by the video cameras and comparing it to the positional information in the current time frame. Positional information used to track the package along the transporting system include xy-coordinates, the dimensions of the package, and the orientation of the package on the transport surface.

A number of assumptions are used to match detections from a current frame with packages identified in a previous frame, as follows:
i) A package could not have moved an unreasonable distance between two frames (time between two frames is typically in the range of 1/20 of a second).
ii) A package could not have changed its angle an unreasonable amount between two frames.
iii) A package has the same dimensions throughout its lifetime.
iv) The package's movement vector correlates with the movement command given, which means that it is highly unlikely that the package has moved 1 cm to the right if it was given the command to moved 1 cm to the left.

As already discussed, the physical surface of the transport surface has a chess board-like pattern that makes detection of packages easier and more precise. This is due to the fact that the planning system knows about the chess board pattern, what it looks like, and that this pattern is the same all the time and everywhere on the surface. Therefore, detecting objects on the surface having this pattern becomes easier because the system can use the regularity of the pattern to better detect objects on the surface.

As previously mentioned, and with reference to Figured 15 and 16, the conveying frame 40 comprises a number of empty spaces 72 and the corners of each conveying frame 40, for receiving a number of additional structures. In some cases, the empty spaces 72 may receive mounting structures for the video cameras of the observation system.

In other examples, a second transporting surface may be present comprising a second layer of conveying frames 40 located above a first layer. In this case, the empty spaces provide the support structure on which the second layer of conveying frames is supported.

In planning system that comprises multiple layers of conveying frames, one or more elevator modules are present to allow a package to travel between the different layers. An elevator module is a conveying frame that is able to travel vertically up and down. This is achieved by employing a mechanical elevator systems such as a rack and pinion systems, in the empty spaces 72. In this example four rails would be located in each of the empty spaces 72, each rail having a rack along the vertical length of the rail. The elevator module would include four motors with corresponding gears that are connected to the racks.

Actuation of the motors causes the gears to turn and move the elevator up or down. Further in this example, the transport module also has several rollers that are mounted onto the rails. These rollers provide alignment and stability, ensuring that the elevator module always sits on the rails correctly and the gears remain in good contact with their racks.

A multi-level planning system has a number of advantages. Firstly, the resulting system is very modular. At any point where there is a conveying frame on one level, a new floor or level can be added by simply putting a new set of rails on top of any existing rails. Some large multi-layer systems may use a cable-based elevator system instead of a rack and pinion.

Secondly, the resulting system easily allows for two elevator modules to be placed within the same vertical column, meaning that two elevator modules operate using the same elevating system, whilst allowing the elevator modules to operate independently of one another.

In summary, the planning system comprises hardware and software aspect. The hardware primarily consists of multiple conveying frames, each having a surface that can move packages freely in all directions. This surface may be referred to as an omnidirectional conveyor belt. Optionally, the hardware may include multiple elevator modules to move the transporting surface up and down. Several conveying frames can be stacked on top of one another with elevator modules connecting the different floors together. Both the conveyor module and the transport module are designed such that they can be stacked together in all directions, thus allowing for formation of systems that can cover any surface area and have an arbitrary amount of floors. Packages can then move freely on each floor using the conveyor module(s) and between floors using the elevator module(s). An overarching software system uses video cameras to detect and track packages. It also plans the movement of the packages and implements the appropriate movement controlling routines and procedures.

The planning system is a modular omnidirectional conveyor belt system capable of moving packages freely, in some cases in three dimensions. The system has the ability to perform complex sortation, storage, retrieval, and other sequences of operations with many packages simultaneously in parallel (parallel execution of operations in the same space).

1-23. (canceled)

24. A conveying system for conveying objects comprising:
a plurality of conveyor modules, each conveyor module comprising:
at least one rotatable element comprising an engagement surface configured to engage with a surface of an object to be conveyed;
a driving mechanism configured to rotate the at least one rotatable element such that rotation of the at least one rotatable element causes rotation of the engagement surface and thereby movement of the object; and
a control mechanism comprising a printed circuit board configured to control rotation of the rotatable element via the driving mechanism; and
a conveying frame comprising:
a plurality of apertures, each aperture configured to receive a conveyor module so as to form an array of conveyor modules that together provide a substantially planar conveying surface for conveying objects thereon; and
a control system configured to communicate with the control mechanism of the conveyor module;
wherein each conveyor module is configured to be releasably mounted within an aperture of the plurality of apertures and wherein, by mounting the conveyor module within the aperture, an electrical connection is established between the control mechanism of the conveyor module and the control system of the conveying frame, which facilitates electrical communication between the control system and the mounted conveyor module.

25. The conveying system of claim 24, wherein the control system of the conveying frame comprises a plurality of printed circuit boards arranged on the underside of the conveying frame, each printed circuit board having a PCI connection interface for receiving a portion of the control mechanism of conveyor module to connect the control mechanism to the control system.

26. The conveying system of claim 24, wherein the at least one rotatable element comprises an aperture having a cross-section comprising a plurality of recesses that are configured to engage with corresponding ridges on the shaft of the driving mechanism.

27. The conveying system of claim 24, wherein the driving mechanism comprises a motor, and the motor comprises a plurality of protrusions extending from the motor, the protrusions configured to engage with corresponding recesses within the conveyor module whereby to retain the motor in place within the conveyor module.

28. The conveying system of claim 24, wherein the conveyor module further comprises a first opening arranged in the top of the conveyor module, a second opening arranged in the base of the conveyor module, and a through passageway extending between the first opening and the second opening to allow fluid or objects to pass from the conveying surface to an underside of the conveying frame under the action of gravity, wherein the at least one rotatable element is at least partially located within the through passageway.

29. The conveying system of claim 24, wherein the conveyor module comprises a housing configured to at least partially house the at least one rotatable element, the driving mechanism, and the control mechanism, wherein a portion of the control mechanism extends beyond the housing such that it can engage with the control system of the conveying frame.

30. The conveying system of claim 24, wherein the conveying frame comprises a baseplate having a first slot configured to receive the portion of the control mechanism of each conveyor module and a second slot configured to receive a portion of the through passageway of each conveyor module, and the portion of the through passageway extends further away from the housing than the portion of the control mechanism so as to extend through the second slot in the baseplate.

31. The conveying system of claim 24, wherein the housing comprises a plurality of flanges configured to engage with the conveying frame.

32. The conveying system of claim 24, wherein the housing comprises a pair of flanges located substantially opposite each other on opposing sides of the housing below which is a track extending around the perimeter of the housing, the track configured to receive a length of elastically deformable material.

33. The conveying system of claim 24, wherein the housing comprises at least one magnetic portion located on an upper external surface of the conveyor module that is arranged to provide part of the conveying surface.

34. A conveyor module for a conveying system that includes a conveying frame having a plurality of apertures configured to receive the conveyor module whereby to form part of conveying surface for conveying objects, the conveyor module comprising:
at least one rotatable element comprising an engagement surface configured to engage with a surface of an object to be conveyed;
a driving mechanism configured to rotate the at least one rotatable element such that rotation of the at least one rotatable element causes rotation of the engagement surface and thereby movement of the object, and
a control mechanism configured to control rotation of the rotatable element via the driving mechanism, the control mechanism comprising a printed circuit board arranged to engage with a control system of the conveying frame;
wherein the conveyor module is configured to be releasably mounted within the aperture of the conveying frame;
wherein, by mounting the conveyor module within an aperture of the conveying frame, an electrical connection is established between the control mechanism of the conveyor module and the control system of the conveying frame, which facilitates electrical communication between the conveying frame and the conveyor module.

35. A conveying frame for a conveying system for conveying objects, the conveying frame comprising:
a plurality of apertures, each aperture configured to receive a conveyor module having at least one rotatable element comprising an engagement surface configured to engage with a surface of an object to be conveyed so as to form an array of conveyor modules that together provide a substantially planar surface for conveying objects thereon;
a control system configured to engage with a printed circuit board forming part of a control mechanism of each conveyor module;
wherein each aperture is configured to have a conveyor module releasably mounted within the aperture;
wherein, by mounting a conveyor module within an aperture, an electrical connection is established between the control mechanism of the conveyor module and the control system of the conveying frame, which facilitates electrical communication between the control system and the conveyor module.

36. The conveying frame of claim 35, wherein said conveyor module further comprises a driving mechanism configured to rotate the at least one rotatable element such that rotation of the at least one rotatable element causes rotation of the engagement surface and thereby movement of the object, and
wherein the control mechanism is configured to control rotation of the rotatable element via the driving mechanism, the control mechanism comprising the printed circuit board arranged to engage with the control system of the conveying frame; and
wherein the conveyor module is configured to be releasably mounted within the aperture of the conveying frame.

37. A planning system for planning the movement of an object, comprising:
an information acquisition system configured to obtain object information, wherein the object information comprises a destination location of the object;
a processing system configured to determine a route of the object from the scanning location to the destination location; and
a main control system configured to communicate with a conveying system for conveying objects, wherein the main control system is configured to control driving mechanisms of a plurality of conveyor modules such that the object is moved across a substantially planar surface along the determined route from the scanning location to the destination location through rotation of rotatable elements of the plurality of conveyor modules.

38. The planning system of claim 37, wherein said conveying system comprises:
the plurality of conveyor modules, wherein the plurality of convey modules comprise:
rotatable elements comprising engagement surfaces configured to engage with a surface of the object to be conveyed;
the driving mechanisms, wherein the driving mechanisms are configured to rotate the rotatable elements such that rotation of the rotatable elements cause rotation of the engagement surface and thereby movement of the object; and
control mechanisms comprising printed circuit boards configured to control rotation of the rotatable elements via the driving mechanisms; and
a conveying frame comprising a plurality of apertures configured to receive the plurality of conveyor modules so as to form an array of the conveyor modules that together provide the substantially planar surface for conveying the object thereon; and
wherein the plurality of conveyor modules are configured to be releasably mounted within the plurality of aperture; and
wherein, by mounting a conveyor module within an aperture, an electrical connection is established between the control mechanism of the conveyor module and the control system of the conveying frame, which facilitates electrical communication between the main control system and the mounted conveyor module.
